(19) United States
(12) Patent Application Publication
(10) Pub. No.: US 2005/0255368 A1
(43) Pub. Date: Nov. 17, 2005

(54) High surface area micro fuel cell architecture

(75) Inventors: Ian W. Kaye, Livermore, CA (US); Jennifer E. Brantley, Dublin, CA (US); David Sopchak, Oakland, CA (US)

Correspondence Address: BEYER WEAVER & THOMAS LLP, P.O. BOX 70250, OAKLAND, CA, 94612-0250, US

(73) Assignee: UltraCell Corporation, a California Corporation, Livermore, CA (US)

(21) Appl. No.: 11/127,788

(22) Filed: May 11, 2005

Related U.S. Application Data
(60) Provisional application No. 60/570,545, filed on May 12, 2004.

(51) Int. Cl. H01M 8/24; B05D 5/12

(52) U.S. Cl. 429/38; 427/115

(57) ABSTRACT

The present invention relates to compact and high power density fuel cells. The fuel cells generate electrical energy and include a three-dimensional (3-D) architecture. The 3-D architectures include active surfaces whose dimensions may be varied during fuel cell design in three dimensions. Fabrication of the 3-D architectures may use wafer-processing technologies such as etching and deposition on etched surfaces. Fuel cells described herein provide power densities (power per unit volume or mass) at levels not yet seen in the fuel cell industry; some fuel cells are small enough to fit in a cell phone and power the cell phone.

### CROSS-REFERENCE TO RELATED APPLICATIONS

This application claims priority under 35 U.S.C. § 119(e) from co-pending U.S. Provisional Patent Application No. 60/570,545 entitled “High Surface Area Micro Fuel Cell Architecture” filed on May 12, 2004, which is incorporated by reference in its entirety for all purposes.

### BACKGROUND OF THE INVENTION

The present invention relates to fuel cell technology. In particular, the invention relates to fuel cells designed for portable applications.

Portable electronics devices, such as cell phones and laptops, are increasing in popularity. The introduction of new cell phone technologies promises to drive growth in international markets for these devices. Cell phone manufacturers are developing “full feature” cellular phones that include enhanced data transmission technology, motion video, digital signal management for live TV, and larger color screens. These full feature phones consume added power. For example, one such full feature cell phone consumes 6 watts, as compared to 2 watts used by most conventional and simpler phones.

Most portable electronics devices rely on lithium ion batteries for power. Existing cell phone batteries permit less than 30 minutes of run time at 2 watts. Thus, a barrier to introduction of these new generation cell phones is the lack of a suitable energy source. Demand for alternative energy source increases—for cell phones and other electronics devices.

A fuel cell electrochemically combines hydrogen and oxygen to produce electricity. Fuel cell evolution so far has concentrated on large-scale applications, such as industrial size generators for electrical power back up. The fuel cell industry is racing to produce a micro fuel cell—a fuel cell small enough to power a portable electronics device.

Current micro fuel cell technology stacks Membrane Electrode Assemblies (MEAs) with interleaved bipolar plates that distribute hydrogen fuel and air while providing electrical interconnect. FIG. 1 shows one such fuel cell stack 1 that includes interleaved MEAs 3 and bipolar plates 4. Each MEA 3 is a flat sheet that includes a hydrogen catalyst, an oxygen catalyst and an ion conductive membrane, which selectively conducts protons and electrically isolates the anode and cathode. The fuel cell stack 1 is noted for its two-dimensional design in a plane of the bipolar plates; taking a cross sectional view in any line 2 orthogonal to the plates 4 (the third dimension, z) produces the same cross-sectional dimensions of interleaved MEAs 3 and plates 4, regardless of where in the 2-D plate line 2 cuts.

Two reasons that fuel cells using stack designs have been difficult to miniaturize are the area requirement for the MEA 3 and relatively low cell voltage. Typically about 4-8 cm² of membrane is required per watt (W) of gross power output. An 8 W (gross, which may lead to a net power output for a cell phone around 6 W) stack thus needs a planar plate area of about 32-64 cm². Also, each cell runs at about 0.6-0.7V DC, and so to attain a required system voltage, the MEAs 3 and plates 4 are connected in series and layered on top of each other, resulting in a thick stack and package. No currently available fuel cell stack can power a cell phone while fitting in the phone.

In view of the foregoing, alternative fuel cell architectures would be desirable. In addition, techniques that reduce fuel cell size and improve power density would be beneficial.

### SUMMARY OF THE INVENTION

The present invention relates to compact and high power density fuel cells. The fuel cells generate electrical energy and include a three-dimensional (3-D) architecture. The 3-D architecture includes active surfaces whose dimensions may be varied during fuel cell design in three dimensions. Fabrication of the 3-D architectures may use wafer-processing technologies such as etching and deposition on etched surfaces. Fuel cells described herein provide power densities (power per unit volume or mass) at levels not yet seen in the fuel cell industry; some fuel cells are small enough to fit in a cell phone and power the cell phone.

The present invention also permits modular cell design in a fuel cell and custom electrical connectivity. In one embodiment, the electrical connectivity includes individual addressing to each anode and cathode structure. This allows each cell to be connected in series or parallel, as desired, to achieve a required voltage or power output. Redundant addressing may also be employed to remove dependence on any single anode or cathode structure and improve robust delivery of power in the event of a failure of one anode or cathode structure. Using a controller or switch, and when coupled with redundant electrical provision, the present invention provides a fuel cell that permits digital control of power output at varying voltages to one or more electrical outputs.

In one aspect, the present invention relates to a fuel cell for generating electrical energy. The fuel cell comprises a set of cells arranged on at least one chassis. Each cell includes an anode structure, a cathode structure and an electrolyte. The anode structure extends from the at least one chassis and supports a hydrogen catalyst. The cathode structure extends from the at least one chassis and supports a cathode catalyst. The electrolyte is disposed to electrically isolate the anode structure from the cathode structure an d permi t passage of ions between the anode structure and the cathode structure. The fuel cell also comprises a hydrogen distribution channel configured to deliver hydrogen to the anode structures in the set of cells. The fuel cell further includes an oxygen distribution channel configured to deliver oxygen to the cathode structures in the set of cells.

In another aspect, the present invention relates to a fuel cell for generating electrical energy that provides a power density of greater than about 20 Watts/cubic centimeters according to a volume of the fuel cell.

In yet another aspect, the present invention relates to a fuel cell for generating electrical energy. The fuel cell includes independent electrical connectivity to the anode structure and the cathode structure in each cell.

In a manufacturing aspect, the present invention relates to a method of fabricating a fuel cell. The method includes forming a set of set of anode structures that each extend from at least one planar chassis and a set of set of cathode structures that each extend from the at least one planar chassis. The method also includes forming electrical connectivity with the set of anode structures and the set of cathode structures. The method further includes depositing an anode catalyst onto surfaces of the set of anode structures. The method additionally includes depositing a cathode catalyst onto surfaces of the set of cathode structures. The method also includes depositing an electrolyte at least partially between the set of anode structures and the set of cathode structures.

These and other features and advantages of the present invention will be described in the following description of the invention and associated figures.

### BRIEF DESCRIPTION OF THE DRAWINGS

FIG. 1 shows a conventional fuel cell stack with interleaved MEAs and bipolar plates.

FIG. 2A illustrates a fuel cell system for producing electrical energy in accordance with one embodiment of the present invention.

FIG. 2B illustrates a reformed fuel cell system in accordance with another embodiment of the present invention.

FIG. 3A shows an outer top perspective view of one layer of anode and cathode structures for a fuel cell in accordance with another embodiment of the present invention.

FIG. 3B shows a top view of a single cell in the fuel cell of FIG. 3A.

FIG. 3C shows an external side view of the cell of FIG. 3B.

FIG. 3D shows a vertical cross section of the cell of FIG. 3B as taken through plane D-D of FIG. 3B.

FIG. 3E shows a horizontal cross section of the cell of FIG. 3B as taken through plane B-B of FIG. 3C.

FIG. 3F shows an outer top perspective view of the cell of FIG. 3B.

FIG. 4A illustrates a simplified cross section architecture of electrochemical conversion components included in a 3-D fuel cell in accordance with one embodiment of the present invention.

FIGS. 4B and 4C show expanded and simplified cross-sections of a cathode junction and an anode junction included in the architecture of FIG. 4A.

FIG. 5 illustrates the etch layering of a wafer scale 3-D fuel cell in accordance with a specific embodiment of the present invention.

FIG. 6A shows a top perspective view of a 3-D fuel cell with its top chassis removed to illustrate the spatial arrangement of individual cells in accordance with one embodiment of the present invention.

FIG. 6B illustrates an outer side view of an individual cell used in the fuel cell of FIG. 6A.

FIG. 6C illustrates a cross-section side view of the cell used in the fuel cell of FIG. 6A.

FIGS. 6D and 6E show simplified dimensions and electrical relationships, respectively, of cells included in the fuel cell of FIG. 6A.

FIG. 7 illustrates a manufacturing process for fabricating a fuel cell in accordance with one embodiment of the present invention.

FIG. 8 shows a dual sided layer in which anode structures are disposed on one face of a single chassis and cathode 276 are disposed on the opposite face of the chassis in accordance with a specific embodiment of the present invention.

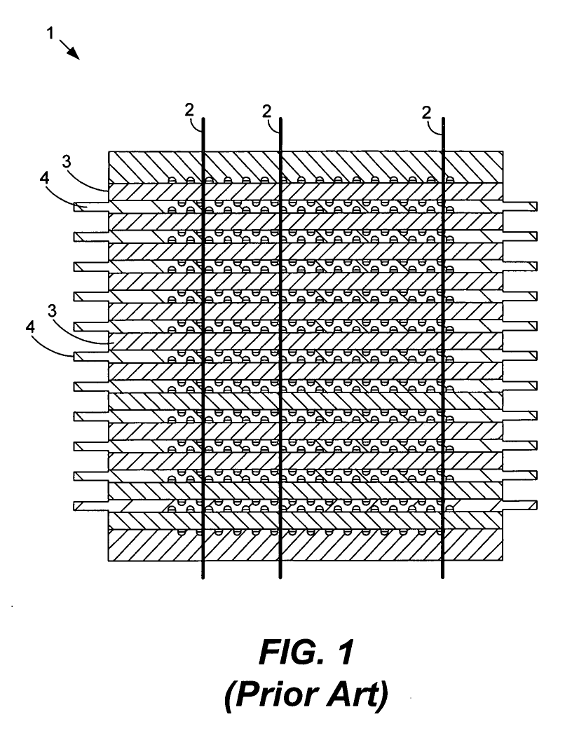

### DETAILED DESCRIPTION OF THE PREFERRED EMBODIMENTS

The present invention is described in detail with reference to a few preferred embodiments as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

### Fuel Cell System

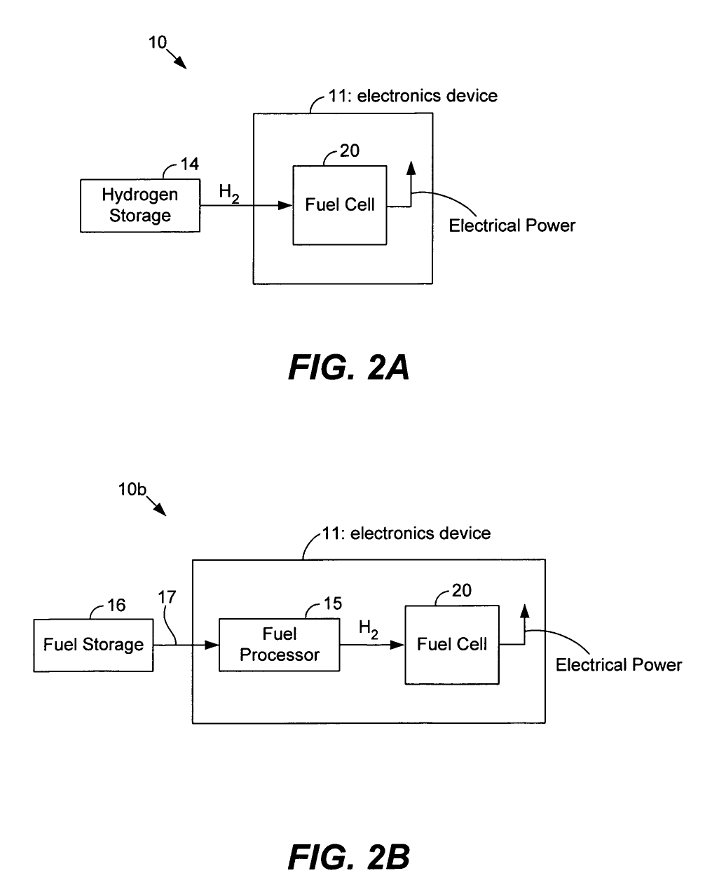

FIG. 2A illustrates a fuel cell system 10 for producing electrical energy in accordance with one embodiment of the present invention. Fuel cell system 10 includes an electronics device 11 powered by a fuel cell 20, which couples to a hydrogen storage device 14.

Hydrogen storage device 14 stores and outputs hydrogen, which may be a pure source such as compressed hydrogen held in a pressurized container 14. Storage device 14 may also include a solid-hydrogen system such as a metal-based hydrogen system known to those of skill in the art. An outlet of hydrogen storage device 14 detachably couples to fuel cell 20 and/or electronics device 11 so that storage device 14 may be replaced when depleted.

Fuel cell 20 electrochemically converts hydrogen and oxygen to water, generating electrical energy and heat in the process. Ambient air commonly supplies oxygen for fuel cell 20. A pure or direct oxygen source may also be used for oxygen supply. The water often forms as a vapor, depending on the temperature of fuel cell 20 components. For some fuel cells, the electrochemical reaction may also produce carbon dioxide as a byproduct.

Fuel cell 20 generates dc voltage, which may be used in a wide variety of applications. For example, electrical energy generated by fuel cell 20 may power a motor 11 or light 11. In one embodiment, the present invention provides ‘small’ fuel cells that are configured to output less than 200 watts of power (net or gross). Fuel cells of this size are commonly referred to as ‘micro fuel cells’ and are well suited for use with portable electronics devices 11. In one embodiment, fuel cell 20 is configured to generate from about 1 milliwatt to about 20 Watts. In another embodiment, fuel cell 20 generates from about 2 Watts to about 10 Watts. Fuel cell 20 may be a stand-alone fuel cell, which is a single package that produces power as long as it has access to a) oxygen and b) hydrogen or a hydrocarbon fuel supply. A stand-alone fuel cell 20 that outputs from about 20 Watts to about 100 Watts is well suited to power a laptop computer 11. One specific fuel cell package produces greater than about 5 Watts. Another specific fuel cell package produces greater than about 8 Watts.

Electronics device 11 may include any device that consumes electrical energy generated by fuel cell 20. Examples include laptop computers, handheld computers and PDAs, cell phones, lights such as flashlights, radios, etc. Fuel cells described herein are useful to power a wide array of electronics devices, and in general, the present invention is not limited by what device receives power from a fuel cell.

Fuel cell 20 is a “three-dimensional” fuel cell, which indicates that it employs an architecture characterized differently in three dimensions. Several suitable three-dimensional architectures are described below. The three-dimensional architectures increase the active surface area for electrochemical processing and thereby boost energy production per volume, which is particularly useful for micro-fuel cells where fuel cell volume and power density are priorities. The architectures include an arrangement of anode structures and cathode structures, arranged in three-dimensions, which boosts surface area interaction between the anode, cathode and an electrolyte. One three-dimensional design employs a set of cell “platelets” for anode structures and cathode structures that extend vertically from a planar chassis. Another architecture uses an array of tubular anode and cathode structures that extend vertically from a planar chassis. Controlling the planar dimensions and vertical dimensions extending therefrom provides three-dimensional control of active surface areas for a fuel cell during design. Three-dimensional architectures described herein may be considered structurally analogous to micro-channel heat sinks whose designs offer increased surface area for thermal dissipation, except the present invention uses the increased surface area to augment electrical energy production capacity. In one embodiment, the fuel cell structure walls are porous, catalyzed (e.g., with a coating including the catalyst) and an electrolyte is located within the porous walls. The combined porous structure walls, embedded catalyst and electrolyte form a ‘matrix’.

In one embodiment, fuel cell 20 includes a set of anode structures that extend from a planar support chassis, and a set of cathode structures that extend from the same support chassis or another support chassis. The anode structures contain the hydrogen catalyst. The cathode structures contain the oxygen catalyst and permit the output of water (typically as a vapor).

In one embodiment, fuel cell 20 is a low volume ion conductive fuel cell. An ion conductive fuel cell 20 includes a hydrogen catalyst, an oxygen catalyst and an electrolyte. The electrolyte is disposed at least partially between the set of anode structures and the set of cathode structures, and a) selectively conducts protons or other ions used in the fuel cell and b) electrically isolates the hydrogen catalyst from the oxygen catalyst.

To generate electrical energy, the hydrogen catalyst separates the hydrogen into protons and electrons. The electrolyte blocks the electrons, and electrically isolates the chemical anode (anode structures and hydrogen catalyst) from the chemical cathode (cathode structures and oxygen catalyst). The electrolyte also selectively conducts positively charged ions. Electrically, the anode conducts electrons to a load (electrical energy is produced) or battery (energy is stored). Meanwhile, protons move through the electrolyte. The protons and used electrons subsequently meet on the cathode side, and combine with oxygen to form water. The oxygen catalyst facilitates this reaction. One common oxygen catalyst comprises platinum powder very thinly coated with a carbon layer on surfaces of the cathode structures. Many fuel cell designs deposit the catalyst on rough and porous cathode structures that increase surface area of the platinum exposed to oxygen.

Hydrogen distribution in fuel cell 20 occurs via one or more hydrogen distribution channels configured to deliver hydrogen to the set of anode structures, while oxygen distribution occurs via one or more oxygen distribution channels configured to deliver oxygen to the set of cathode structures.

Electrically and chemically for fuel cell 20, the anode comprises the set of anode structures and hydrogen catalyst, while the cathode comprises the set of cathode structures and oxygen catalyst. The anode acts as the negative electrode for fuel cell 20 and conducts electrons freed from hydrogen molecules so that they can be used externally, e.g., to power an external circuit. In a fuel cell stack, the anode structures may be connected in series to add electrical potential gained in each anode structure in the set. The cathode represents the positive electrode for fuel cell 20 and conducts the electrons back from the external electrical circuit to the oxygen catalyst, where they can recombine with hydrogen ions and oxygen to form water.

Fuel cell 20 permits a designer to tailor electrical connectivity to the set of anode structures and the set of cathode structures. In one embodiment, the electrical connectivity includes independent (e.g., individual) addressing to each anode and cathode structure. This allows each anode and/or cathode structure to be connected in series or parallel, as desired, to achieve a required voltage or power output. Redundant addressing may also be employed to remove dependence on any single anode or cathode structure and improve robust delivery of power in the event of a failure of one anode or cathode structure.

The present invention yields a fuel cell that has enlarged surface area but a reduced volume relative to conventional planar stack designs. Many fuel cells described herein occupy less than about 10 cubic centimeters (cc), as determined by volume of the functional components in the fuel cell for electrical energy generation. In another embodiment, the fuel cell occupies less than about 5 cc. Fuel cells of the present invention constructed using wafer fabrication technology may occupy less than about 1 cubic centimeter. These fuel cells provide a reduced form factor permits fuel cell integration into a cell phone and other small electronics devices. Greater and other volumes are suitable for use herein.

The 3-D architectures also yield micro fuel cell power densities far above conventional stack designs. In one embodiment, a 3-D fuel cell provides greater than about 20 watts/cc. More compact and powerful designs may produce greater than about 100 watts/cc. Some fuel cell may approach 250 W/cc in power density.

While the present invention will mainly be discussed with respect to electrolyte-based fuel cells, it is understood that architectures described herein may be practiced with other chemical designs. The main difference between chemical designs is the type of ion conductive electrolyte used. In one embodiment, fuel cell 20 is phosphoric acid fuel cell that employs liquid phosphoric acid for ion exchange. Solid oxide fuel cells employ a hard, non-porous ceramic compound for ion exchange and may be suitable for use with the present invention. Generally, any fuel cell chemical design may benefit from the space saving designs described herein. Other such fuel cell architectures include direct methanol, alkaline and molten carbonate fuel cells, for example.

A fuel cell of the present invention may also use a ‘reformed’ hydrogen supply. FIG. 2B illustrates a fuel cell system 10b for producing electrical energy in accordance with another embodiment of the present invention. For fuel cell system 10b, an electronics device 11 includes a fuel processor 15 and fuel cell 20.

Processor 15 processes a fuel source 17 to produce hydrogen. Fuel source 17 acts as a carrier for hydrogen and can be manipulated to separate hydrogen. Fuel source 17 may include any hydrogen bearing fuel stream, hydrocarbon fuel, or other hydrogen fuel source such as ammonia. Currently available hydrocarbon fuel sources 17 suitable for use with the present invention include methanol, ethanol, gasoline, propane, butane and natural gas, for example. Liquid fuel sources 17 offer high energy densities and the ability to be readily stored and shipped. Other fuel sources may be used with a fuel cell package of the present invention, such as sodium borohydrate. Several hydrocarbon and ammonia products may also produce a suitable fuel source 17.

Fuel source 17 may be stored as a fuel mixture. When the fuel processor 15 comprises a steam reformer, storage device 16 contains a fuel mixture of a hydrocarbon fuel source and water. Hydrocarbon fuel source/water fuel mixtures are frequently represented as a percentage fuel source in water. In one embodiment, fuel source 17 comprises methanol or ethanol concentrations in water in the range of 1%-99.9%. Other liquid fuels such as butane, propane, gasoline, military grade “JP8” etc. may also be contained in storage device 16 with concentrations in water from 5-100%. In a specific embodiment, fuel source 17 includes 67% methanol by volume.

As shown, the reformed hydrogen supply comprises a fuel processor 15 and a fuel source storage device 16. Storage device 16 stores fuel source 17, and may comprise a portable and/or disposable fuel cartridge. A disposable cartridge offers a user instant recharging. In one embodiment, the cartridge includes a collapsible bladder within a hard protective case. A fuel pump typically moves fuel source 17 from storage device 16 to the processor 15. If package 10 is load following, then a control system meters fuel source 17 to deliver fuel source 17 to processor 15 at a flow rate determined by a desired power level output by fuel cell 20.

Fuel processor 15 processes the hydrocarbon fuel source 17 and outputs hydrogen. A hydrocarbon fuel processor 15 heats and processes a hydrocarbon fuel source 17 in the presence of a catalyst to produce hydrogen. Fuel processor 15 comprises a reformer, which is a catalytic device that converts a liquid or gaseous hydrocarbon fuel source 17 into hydrogen and carbon dioxide.

In one embodiment, fuel processor 15 is a steam reformer that only needs steam to produce hydrogen. Several types of reformers suitable for use in fuel cell package 10 include steam reformers, auto thermal reformers (ATR) or catalytic partial oxidizers (CPOX). ATR and CPOX reformers mix air with the fuel and steam mix. ATR and CPOX systems reform fuels such as methanol, diesel, regular unleaded gasoline and other hydrocarbons. In a specific embodiment, storage device 16 provides methanol 17 to fuel processor 15, which reforms the methanol at about 250° C. or less and allows fuel cell package 10 use in applications where temperature is to be minimized.

Fuel cell 20 may receive hydrogen from either a direct hydrogen supply 12 or a reformed source. Fuel cell 20 typically receives hydrogen from one supply at a time, although fuel cell packages that employ redundant hydrogen provision from multiple supplies are useful in some applications.

### Exemplary 3-D Fuel Cell Designs

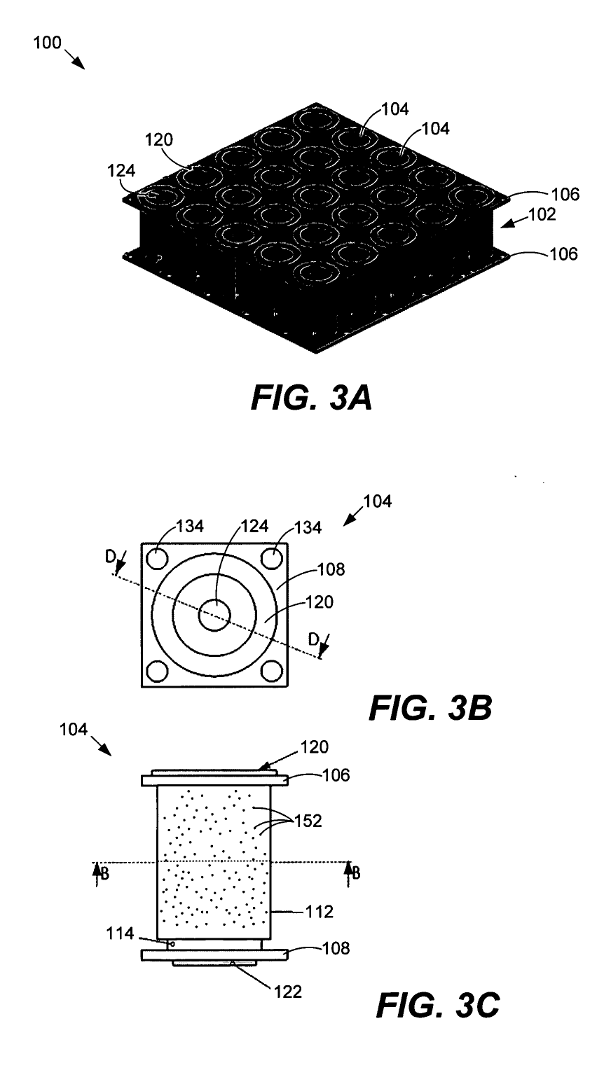

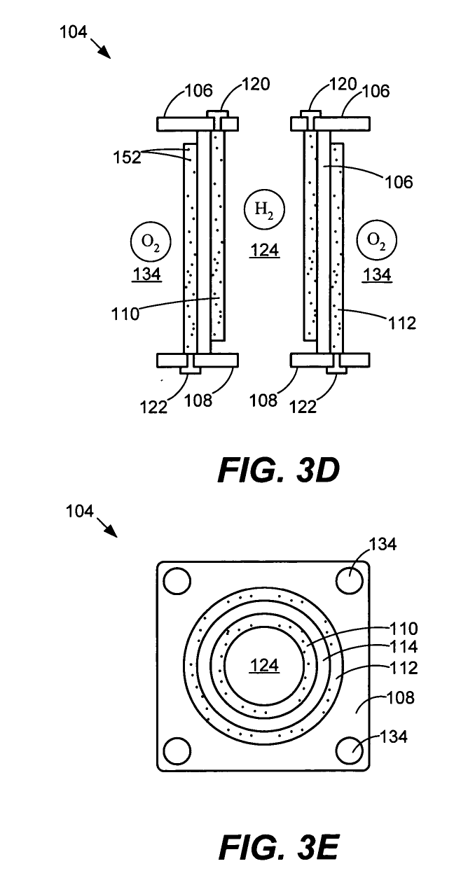

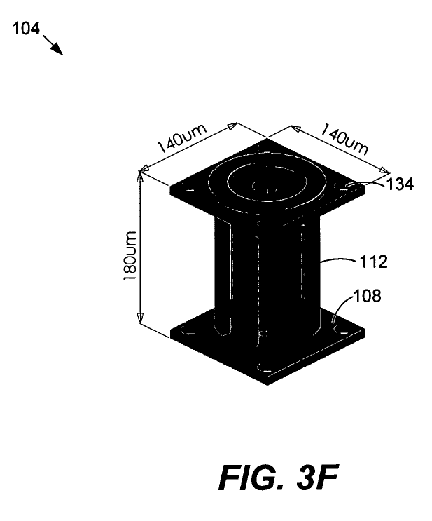

FIGS. 3A-3F illustrate components a three-dimensional fuel cell 100 in accordance with one embodiment of the present invention. FIG. 3A shows an outer top perspective view of one layer 102 of cells 104 included in fuel cell 100. FIG. 3B shows a top elevation view of a single cell 104 in fuel cell 100. FIG. 3C shows an external side view of cell 104. FIG. 3D shows a vertical cross section of cell 104 as taken through plane D-D of FIG. 3B. FIG. 3E shows a horizontal cross section of cell 104 as taken through plane B-B of FIG. 3C. FIG. 3F shows an outer top perspective view of cell 104.

Referring initially to FIG. 3A, fuel cell 100 includes a planar array 102 of cells 104 that rest between top support chassis 106 and a bottom support chassis 108. Cell 104 represents the basic building unit for fuel cell 100. The chassis 106 and 108 provide structural backing, location and connectivity for the anode and cathode structures mechanically included in each cell 104 and coupled thereto. In one embodiment, each chassis 106 and 108 includes an insulating material. Suitable insulating materials include silicon oxide, silicon Carbide or glass, for example. In a specific embodiment, components in each cell 104 are etched out of a material deposited onto each chassis 106 and 108, and the remaining material that was not etched away forms the chassis 106 and 108. Other support structures can be used to form one or more chassis. Top and bottom end plates may also be added outside chassis 106 and chassis 108, respectively, to provide mechanical protection.

Referring to FIG. 3D, each cell 104 includes an anode structure 110, a cathode structure 112 and an electrolyte 114. In this case, anode structure 110 and cathode structure 112 are both substantially cylindrical and separated by a small gap in which cylindrical electrolyte 114 is located. Electrolyte 114 resembles a cylindrical layer that is disposed between concentric cylindrical anode and cathode structures 110 and 112. In a specific embodiment, the small gap and the structures 110 and 112 are coated with electrolyte 114, such as phosphoric acid or Nafion (DuPont).

Anode structure 110, or a conductor included therein, electrically serves as the lower potential or negative electrode for each cell 104 and conducts electrons that are freed from hydrogen molecules so they can be used externally. Anode structure 110 mechanically couples to top support chassis 106 and extends downwards therefrom. As shown, top support chassis 106 is substantially planar and cylindrical walls of anode structure 110 extend substantially normal from the plane of chassis 106. Anode structure 110 may be conductive, semi-conductive, or non-conductive. Suitable electrically conductive structure 110 materials include doped silicon, silicon carbide or graphite, for example. Metals such as aluminum and copper are also suitable for use. Other materials may be used and are described below. In one embodiment, and as will be described further below, anode structure 110 and cathode structure 112 each include a porous material with their respective catalysts deposited on the porous surfaces.

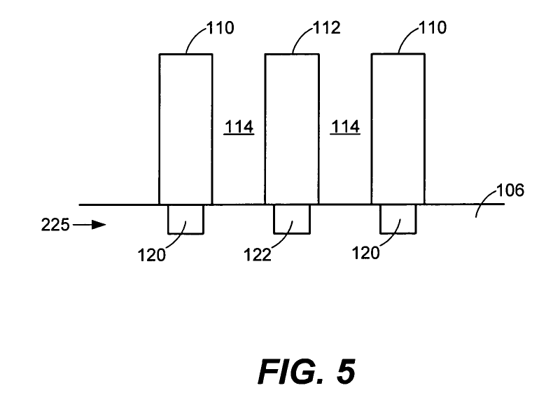

Fuel cell 100 includes electrical connectivity to the set of anode structures 110. An anode interconnect 120 is included in top support chassis 106 and permits electrical communication with anode structure 110. Interconnect 120 includes a conductor that passes through the insulating top support chassis 106, and may connect to an anode bus. The bus (FIG. 5) electrically couples anode connectors 120 in planar array 102. The bus layer may be arranged such that a correct number of cells 104 connect in series or parallel to achieve a desired stack voltage or electrical power output for fuel cell 100.

In one embodiment, each anode structure 110 includes independent electrical connectivity. This implies that each anode structure has its own dedicated electrical interconnect 120. As will described in further detail below, independent electrical connectivity to the set of anode structures 110 may to provide various electrical features, such as addressing and redundant electrical provision that overcomes reliance on any single cell 104 and minimizes sensitivity to failure of any cell 104.

Anode structure 110 includes a hydrogen catalyst 126. Hydrogen catalyst 126 (also known as an anode catalyst) breaks hydrogen into protons and electrons. In one embodiment, the hydrogen catalyst is coated onto surfaces of anode structure 110 and forms a catalyst layer, e.g., on porous surfaces of holes 152 that increase surface area interaction and power density of cell 100. The catalyst layer may include catalytically active particles or materials that are known to those of skill in the fuel cell arts. One suitable hydrogen catalyst 126 is platinum. One advantage of using a platinum catalyst is that it is conductive enough to doubly function as a conductive layer, and thereby reduce conductive requirements on anode structure 110. Other suitable hydrogen catalysts include platinum group metals such as ruthenium, rhodium, iridium, and their electro conductive oxides. Other precious metals and catalysts may also be used. Suitable catalysts 126 also include ruthenium, and platinum black or platinum carbon, and/or platinum on carbon nanotubes, for example.

In one embodiment, anode structure 110 is coated with an electrically conductive metal alloy or polymeric materials to improve conductance. The electrically conductive coating a) increases the electrical conductivity of anode structure 110 between catalyst locations and the electrical interconnect, and b) enhances current transfer between the hydrogen catalyst 126 and electrolyte 114. The conductive coating also serves as an electronic conduction path when anode structure 110 is formed from non-conductive materials. The electrically conductive layer may include graphite, a conductive metal alloy or polymeric material, for example.

The relatively small size of fuel cell 100 and the anode (and cathode) structures permits the use of non-traditional and relatively expensive coatings. These coatings may comprise gold, titanium carbide, titanium nitride or composite materials, for example. Fuel cell manufactures of large fuel cells (2 kW and up) typically avoid costly coatings due to the high cost of coating many square meters of material. However, for small fuel cells, the low cost and performance increase associated with more efficient anode and cathode structures (increased performance reduces the overall size of the fuel cell, reduces electrolyte size and amount of catalyst required) outweighs the cost of the coating.

In general, anode structure 110, a conductive coating applied thereto, or another electrode mechanism, is conductive enough to communicate any electrical energy from the hydrogen catalysts 126 to anode connector 120. In one embodiment, resistance through anode structure 110 is less than 100 mOhm cm², whether achieved with a conductive substrate material for anode structure 110 or via an external conductive coating. If the catalyst layer is sufficiently conductive, or structure 110 includes another suitable mechanism for communicating electrical energy from all catalyst sites to interconnect 120, then anode structure 110 does not need to be made from an electrically conductive material.

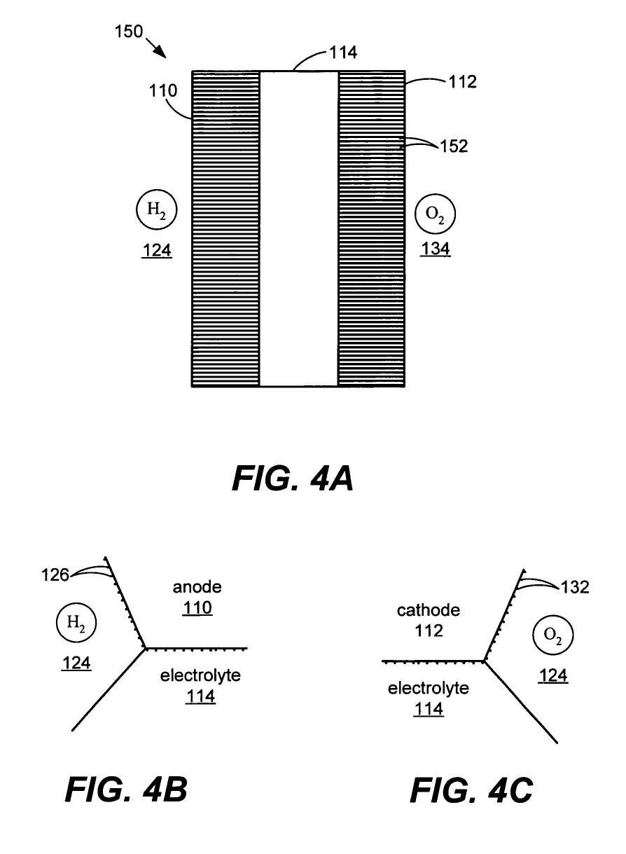

Cathode structure 132, or a conductor included therein, represents the positive electrode for each cell 104 and conducts electrons to an oxygen catalyst 134, where they can recombine with hydrogen ions and oxygen to form water. Cathode structure 112 mechanically couples to bottom support chassis 108 and extends upwards therefrom. As shown, bottom support chassis 108 is substantially planar, about parallel to top support chassis 106, and cylindrical walls of cathode structure 112 are about normal to the plane of chassis 108 and 106. In one embodiment, cathode structure 112 includes a porous material with an oxygen catalyst 132 (FIG. 4B) deposited on the porous surfaces. Cathode structure 112 may also be conductive, semi-conductive, or non-conductive. Suitable electrically conductive structure 112 materials include doped silicon, silicon carbide, or graphite, for example. Other suitable cathode structure materials may include one or more of: iron, nickel, stainless steel, a thermally decomposed product of a nickel salt, Raney nickel, stabilized Raney nickel, carbonyl nickel and carbon powder supporting a platinum group metal. The catalyst may be supported or unsupported.

A cathode electrical interconnect 122 is included in bottom support chassis 108 and permits electrical connectivity and communication with cathode structure 112. In one embodiment, fuel cell 100 includes independent electrical connectivity and each cathode structure 112 includes its own interconnect 122. Interconnect 122 passes through the bottom support chassis 108 and may connect to a cathode bus. The cathode bus electrically couples interconnects 122 in the planar array 102.

Cathode structure 112 includes an oxygen catalyst 132 (FIG. 4C). In one embodiment, the oxygen catalyst 132 is coated onto porous surfaces of cathode structure 112 and forms an oxygen catalyst layer. The layer can be made from catalytically active particles or materials that are known to those of skill in the art. One suitable oxygen catalyst 132 is platinum. Other suitable oxygen catalyst 132 includes platinum nickel alloy, and platinum ruthenium alloy, for example.

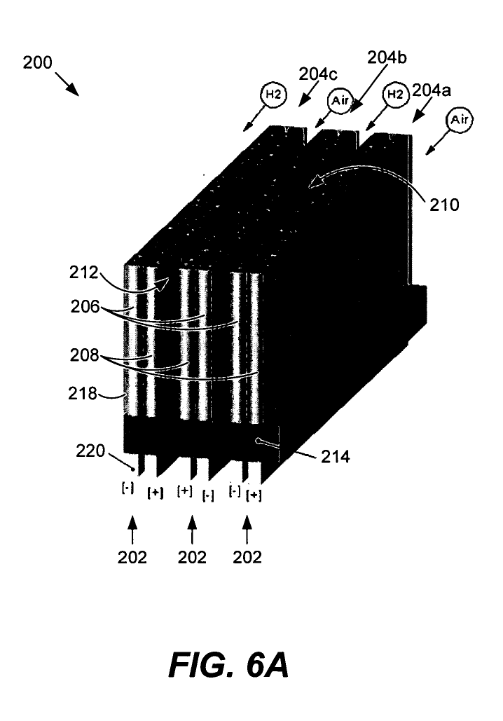

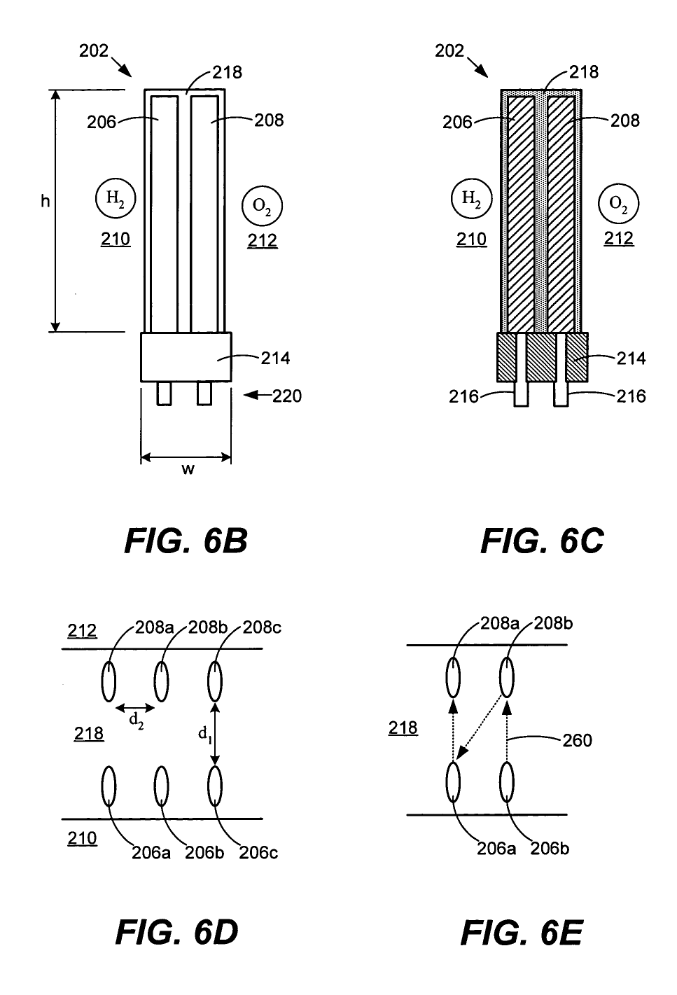

In an insulating chassis embodiment, electrically conductive anode and cathode structures 110 and 112 are fixed on one or more insulating chassis with electrical interconnects 120 that feed through the insulator. For fuel cell 100, the anode and cathode electrical interconnects 120 and 122 are located on separate insulating support chassis 106 and 108. However, both anode and cathode interconnects may be deposited on the same chassis and insulating layer (see FIGS. 6A-6E for example).

Electrolyte 114 is disposed at least partially between the set of anode structures 110 and the set of cathode structures 112. For the cylindrical embodiment shown electrolyte 114 rests between an inner anode cylinder 110 and an outer concentric cathode cylinder 112. Electrolyte 114 may be a solid, gel, or liquid. A solid electrolyte 114 may be held in place by capillary forces, or may be physically bonded to structures 110 and 112. A liquid electrolyte 114 may include sealing in the fuel cell to contain the liquid.

Electrolyte 114 electrically isolates the anode from the cathode by blocking electrons from passing therethrough. In this case, electrolyte 114 prevents the passage of electrons between each anode structure 110 and cathode structure 112 for a cell 104. Electrolyte 114 also selectively conducts positively charged ions, e.g., hydrogen protons from anode structure 110 to cathode structure 112. Electrolyte 114 comprises any material that allows for ionic conductivity therethrough. One electrolyte suitable for use with fuel cell 20 is yitria stabilized zirconia. Electrolyte 114 may also employ a phosphoric acid matrix that includes a porous separator impregnated with phosphoric acid. Alternative electrolytes 114 suitable for use with fuel cell 100 are widely available from companies such as United technologies, DuPont, 3M, and other manufacturers known to those of skill in the art.

A hydrogen distribution channel 124 centrally passes through the center of each tubular cylindrical anode structure 110 and delivers hydrogen to surfaces of anode structure 110. Porous surfaces of anode structure 110 increase the surface area interaction with hydrogen in channel 124. Channel 124 includes a hole or port in top chassis 106 and a hole in bottom chassis 108, where one-hole functions as a hydrogen inlet for cell 104 and the other functions as a hydrogen outlet. Hydrogen distribution to each cell 104 may then occur using a manifold placed over layer 102 and chassis 106 (or 108, depending on configuration). Similarly, hydrogen collection for layer 102 may occur using a manifold placed adjacent to the other chassis. If hydrogen consumption is complete (as is common in a dead-ended anode fuel cell), then cell 104 need not include a second exhaust port. Although hydrogen distribution to each cell includes a single channel as shown, multiple channels to each cell 104 may be used.

FIGS. 3E and 3F show the top chassis 108 and four oxygen ports 134 that pass through top chassis 108 and open into a volume surrounding the cylindrical cathode structure 112. In this embodiment, the oxygen distribution channel 134 for fuel cell 104 includes the volume of each cell 104 that surrounds the cylindrical cathode structure 112 serviced by the oxygen ports 134. The outer oxygen distribution channel 134 delivers oxygen to surfaces of the cathode structure 112. Other numbers or ports and oxygen delivery configurations may be used. In another embodiment, cathode distribution channel 134 may include one large contiguous volume between all cells 104 in layer 102. This provides an oxygen distribution channel that is about parallel to the planar chassis and permits channel 134 to be ventilated from the side, rather than holes in the top or bottom of each chassis. This also allows for greater flexibility in oxygen plumbing, providing reactant gases to each cell 104, and removing product gases (including water vapor) from each cell 104. For example, the z-axis may be devoted to anode plumbing and gas flow while the x-y plane to cathode ventilation.

FIG. 4A illustrates a simplified cross section architecture 150 of electrochemical conversion components included in fuel cell 100 in accordance with one embodiment of the present invention. FIGS. 4B and 4C show expanded cross-sections of a cathode junction and an anode junction included in architecture 150.

As shown, architecture 150 includes anode structure 110, cathode structure 112, electrolyte 114 sandwiched between the anode and cathode structures, hydrogen distribution channel 124, and oxygen distribution channel 134. Fuel cell architecture 150 is illustrative of the electrochemical structure, in each cell 104 of fuel cell 100, that converts hydrogen and oxygen to water and generates electrical energy and heat in the process.

Anode structure 110 and cathode structure 112 each include a porous structure. Electrolyte 114 fills the porous holes 152. Hydrogen catalyst 126 is deposited on the porous surfaces of anode structure 110, while oxygen catalyst 134 is deposited on the porous surfaces of cathode structure 112. For example, the platinum may reside as a powder very thinly coated onto the porous walls. The porous design increases surface area interaction with each catalyst. While lateral and straight lines 152 are used to demonstrate porosity in FIG. 4A, it is understood that the porous structure is typically not so physically simple. In one embodiment, the electrolyte 114 is filled into the pores 152 after a catalyst layer has been deposited onto the surfaces.

Hydrogen gas (H₂), such as that provided in a hydrogen bearing gas stream (or ‘reformate’), enters fuel cell 100 via a hydrogen port for the fuel cell 100, proceeds through an inlet hydrogen manifold (not shown) that carries the hydrogen gas to the hydrogen distribution channels 124, which centrally passes through the center of each cylindrical anode structure 110. In one embodiment, the hydrogen is pressurized when entering the fuel cell. The pressure forces hydrogen gas into the hydrogen-permeable electrolyte 114 and across the hydrogen catalyst 126, which is coated on the anode structure 1110. When an H₂ molecule contacts hydrogen catalyst 126, it splits into two H+ ions (protons) and two electrons (e−). The protons move through electrolyte 114 to combine with oxygen. The electrons conduct through the anode structure 110, where they build potential for use in an external circuit (e.g., a power supply of a laptop computer) After external use, the electrons flow to the cathode structure 112.

On the cathode side of architecture 150, pressurized air carrying oxygen gas (O₂) enters fuel cell 100 via an oxygen port that communicates the oxygen to an oxygen manifold, which delivers the oxygen-to-oxygen channels 134. The oxygen channels 134 open to surfaces of cathode structure 112. The pressure forces oxygen to interact with the oxygen catalyst 134 disposed at the boundary of the cathode structure 112 and electrolyte 114 in pores 152. When an O₂ molecule contacts oxygen catalyst 132, it splits into two oxygen atoms. Oxygen catalyst 134 facilitates the reaction of oxygen and hydrogen to form water. One common catalyst 134 comprises platinum. Two H+ ions that have traveled through electrolyte 114 and an oxygen atom combine with two electrons returning from the external circuit to form a water molecule (H₂O). Oxygen channels 134 exhaust the water, which usually forms as a vapor.

Cell 104 represents the basic functional unit for fuel cell 100. In this case, cell 104 provides a tubular surface area interaction between the electrolyte 114, conductive structure 110 and hydrogen catalyst, and a tubular surface area interaction between the electrolyte 114, conductive structure 112 and oxygen catalyst. The anode structure and the cathode structure share a central axis that is about normal to the planar chassis 106 and 108. Other geometries and configurations may be used. Hexagonal, elliptical square, or other n-sided cells 104 may also be employed, for example. In one embodiment, configuration of each cell 104 is designed to increase surface area between the conductive structures 110 and 112, their respective catalysts, and electrolyte 114.

Arrangement of cells 104 will also affect packing density and increase surface area interaction and power output of fuel cell 100. FIG. 3A shows one layer 102, of cells 104; multiple layers may be used. Hexagonal packing may also increase packing density in a single layer, for example. Optimal arrangement of individual cells 104 in a lateral cathode flow field may also depend on the particular performance requirements and environment of a specific fuel cell device. Cells 104 and layers 102 may be arranged so as to minimize volume. In one embodiment, multiple layers 102 are arranged to be coplanar in a fuel cell. Coplanar in this sense refers to the shortest and/or longest dimension used to characterize the fuel cell and to characterize the fuel processor being aligned in the same axis. The shortest dimension refers to the smallest dimension of three dimensions (e.g., x, y, z) used to characterize size of either component. The longest dimension conveys the opposite. For example, if height of layer 102 is the smallest dimension, then layers 102 are placed adjacent and coplanar to each other such that height for both is in a common direction (e.g., z). The layers 102 may be arranged beside each other, stacked on top of each other, or in any other arrangement that reduces volume. When arranged beside each other, height determines overall height of the fuel cell.

The 3-D operative surfaces awarded by the present invention increase surface area interaction between reactants relative to conventional 2-D stack designs. This increases power density provided by the 3-D fuel cells described herein relative to conventional stack designs. This benefit can be leveraged in several ways: a) smaller (lower volume) fuel cells, such as those that can fit in small electronics devices that were previously undersized for stack fuel cells; b) greater power output for the same size fuel cell; and c) more flexibility in electronics device integration, such as where in a device the fuel cell is situated. For the last issue, generally, the larger the fuel cell, the more difficult physical integration becomes. The present invention, however, provides smaller fuel cells that ease physical integration. In a specific embodiment, the fuel cell package is sized to fit in the existing battery bay of a laptop computer or battery volume of a cell phone.

These 3-D cell 104 geometries and layer 102 arrangements also permit 3-D manipulation of dimensions for cell 104 and active surface area dimensions, which provides flexibility in increasing surface area interaction, increasing power density, and controlling other design parameters such as heat dissipation and gaseous communication. For example, cell 104 permits 3-D control of surface area dimensions (e.g., x,y,z) for gaseous interaction. Increasing the radius of each circular cell 104 increases surface area interaction for that cell, but produces a lower cell density for a layer 102. Cumulative surface area for the layer 102 and fuel cell 100 will then depend on surface area in each cell 104 and packing density of cells 104. The exact radius used is a matter of design choice and will also vary with several design criteria such as plumbing needs and heat dissipation. Dimensions in x, y, and z may all be altered to vary the aggregate amount of active surface area in cell 100. FIG. 3F shows exemplary dimensions for cell 104. Other dimensions may be used in the x, y, and z (or length, width and height) directions shown.

For FIGS. 3A and 3F, the cylindrical cathode structure 112 is shown as discrete segments. Waffled cathode structures may also be used to increase surface area interaction with the incoming oxygen. For FIGS. 3C-3E, the cathode structure 112 is a single cylinder with holes 152 running therethrough to increase triple surface area interaction (FIG. 4C) between the reactant gas supply 134, electrolyte 114 and the catalyst 132 and electrically conducting cathode structure 112. In this case, the cylindrical anode structure 110 or cathode structure 112 typically includes a single cylinder that is not broken into parts. This permits the tubes themselves to be wholly or mostly made out of solid electrolyte or an insulating matrix containing solid electrolyte, with electrodes coated or sputtered or plated on each side. Other structure geometries may be used.

As shown in FIG. 3A, fuel cell 100 includes twenty-five cells 104 and one layer 102. The number of layers 102 and number of cells 104 in each layer 102 may vary with design of fuel cell 100. Stacking parallel layers 102 permits efficient use of space and increased power density for fuel cell 100 and a fuel cell system including fuel cell 100. Each layer 102 may also be extended beyond the cell dimensions shown, e.g., include more than 25 cells per layer.

In one embodiment, each cell 104 produces about 0.6V to about 0.7V DC and the number of cells 104 is selected to achieve a desired voltage. Alternatively, the number of cells 104 and layers 102 may be determined by the allowable thickness of fuel cell 100. A fuel cell 100 having from one cell 104 to several thousand cells 104 is suitable for many applications. A fuel cell 100 having from about one hundred cells 104 to about one thousand cells 104 is also suitable for numerous applications. Fuel cell 100 size and layout may also be tailored and configured to output a given power.

In one embodiment, layer 102 is manufactured using wafer scale processes. FIG. 5 illustrates the etch layering of a wafer scale 3-D fuel cell 100 in accordance with a specific embodiment of the present invention. Fuel cell 100 includes anode structures 110 on opposite sides of a cathode structure 112, where both are deposited on a common chassis 106.

A metal interconnect layer forms electrical connectivity for the cell 100 and is deposited within the insulating chassis 106. Interconnects 120 for the anode and 122 for the cathode are then situated below the surface of the chassis 106 and form a bus layer 225. Fabrication includes etching vias into the substrate included in chassis 106. Metal interconnects are then deposited into the vias, and addressed as anode or cathode interconnects as appropriate. The bus layer 225 thus allows cells 104 to be electrically coupled using the interconnect layer to achieve a desired number of series/parallel cell configurations, as desired, which will depend on the voltage provided by each cell 104 and desired output for the cell 100. Also, interconnects 120 and 122 in the entire 3-D fuel cell 100 can be attached to a switching mechanism that provides voltage regulation for one or more layers 102 or groups of cells 104 within the fuel cell.

In a specific wafer scale process embodiment, a layer 102 can be made from one monolithic, electrically insulating chassis with the anode and cathode catalysts coated on opposite sides, and electrical connections to a bus layer etched into the opposite sides. The chassis may also be comprised of a solid electrolyte, capable of supporting the electrodes entirely on its own, or comprise an insulating porous structure that is infused with a solid electrolyte, such as an alkali metal salt, for example, ammonium polyphosphate or CsHSO4.

3-D designs described herein also offer a high number of cells 104 (if desirable) and other design advantages. For example, a conventional stack including 18 bi-polar plates typically offers 18 cells, a voltage range of 9-10.8V DC, one output channel, and a power conversion efficiency from about 75-92%. By contrast, 3-D designs described herein may offers thousands of cells (which offer variable electrical connectivity), a voltage range from about 0.6 to about 600V DC, hundreds of output channels, and a power conversion efficiency that can approach 100%.

Some fuel cells include redundant cell 104 provision. A redundant set of cells 104 indicates that there are more cells 104 in a fuel cell than are needed for electrical power generation to service a load. Typically, fuel cells with multiple bi-polar plate cells are connected in a series in the bi-polar stack. If one of these cells fails (develops a gas cross over, short circuit, reduced catalytic activity, etc.), the whole stack is taken off line to prevent the bad cell from “going negative”. A redundant set of cells 104 mitigates this problem by including more cells than are needed for electrical output. For example, a fuel may include several hundred cells while only a subset of the cells provide the requisite power output. In one embodiment, a fuel cell uses less than about 90% of its individual cells to service a load. In a specific embodiment, a redundant set of cells 104 uses less than about 80% of its cells to service a load. If a cell goes bad, switching will exclude the inoperable cell from the electrical output, thereby isolating the bad cell, avoiding the bad cell from contaminating other cells, maintaining power provision, and saving fuel cell operability. This may occur for multiple cells. Thus, the 3-D fuel cell with redundancy will increase operating life by avoiding reliance on functionality in every cell. Redundancy also increases manufacturing yield since it avoids having to throw away fuel cells when every cell 104 does not work.

Digital control may then be included to manage redundant cell 104 provision. More specifically, a controller provides control of which cells in the redundant set are currently used to generate electrical energy. The controller thus operates as a switching mechanism that allows different groupings of cells 104 to be connected in series/parallel in order to achieve a desired power level or voltage. The controller is programmed to control the redundant set according to one or more goals. For example, the controller may increase the life and reliability of the fuel cell by cycling cells 104 during power provision. This spreads heat generation and dissipation over a larger area, and avoids peak temperatures in any individual cell or portion of layer 102. Thermal sensors may also be included that provide a temperature signal to the controller that determines when a portion of the layer 102 is too hot relative to other portions, and the controller shuts down cells 104 in this portion, allowing the portion to cool and thereby protecting the cells in the portion.

Switching of cells 104 also allows the fuel cell to offer a voltage range for output. For example, some subset of cells may be used to provide voltage for a small load, while another larger subset of cells are used to provide voltage for a larger load. The cells used may vary with the electrical demands (voltage and current) of the load.

In one embodiment, fuel cell 100 includes multiple electrical outputs. The advantage of having multiple output channels—and variable voltages for each—becomes more apparent in device systems integration. A cell phone requires different bus voltages for different components; the screen, transmitter and CPU all operate at different voltages. Conventionally, boost/buck converters are installed in electronic devices to supply the correct voltage to the different components. A fuel cell of the present invention, however, can supply a separate voltage line to each component, thereby eliminating the need for DC-DC converters. Eliminating the DC-DC converter increases the electrical system efficiency and reduces the cost and size of the electronics.

FIGS. 6A-6D illustrate a 3-D fuel cell 200 in accordance with another embodiment of the present invention. FIG. 6A shows a top perspective view of the fuel cell 200 with its top chassis removed to illustrate the spatial arrangement of individual cells 202. FIG. 6B illustrates an outer side view of an individual cell 202. FIG. 6C illustrates a cross-section side view of cell 202. FIG. 6D shows a simplified top elevated view three cells 202.

Referring initially to FIG. 6A, fuel cell 200 includes three rows 204a-c of cells 202 that also forms rows of anode structures 206 and cathode structures 208. Anode structures 206 from adjacent rows 204 are configured to face each other such that a hydrogen distribution channel 210 running between the two rows 204 runs between two rows of anode structures 206. This allows hydrogen distribution channel 210 to simultaneously service both adjacent anode structure rows. Similarly, cathode structures 208 from adjacent rows 204 face each other such that an oxygen distribution channel 212 running between the two rows 204 can simultaneously provide oxygen delivery to both adjacent cathode rows.

The arrangement in FIG. 6A is repeatable. Thus, although each row 204 is shown with 30 individual cells (30 anode structures 206 and 30 cathode structures 208), the rows 204 can be extended in length as desired to include more cells in each row (or less). In addition, more rows 204 may be added. The added rows are configured such that anode structures 206 from adjacent rows 204 face each other and simplify plumbing and gas provision. Similar to fuel cell 100, fuel cell 200 may include as many cells 204 as desired. Hundreds or thousands of cells 204 are suitable for many fuel cells and applications.

Chassis 214 includes an insulating material and provides structural backing, location and connectivity for anode structures 206 and cathode structures 208. Chassis 214 also seals and defines dimensions of hydrogen distribution channels 210 and oxygen distribution channels 212. A top chassis may be included (but is not shown to facilitate illustration).

Referring to FIGS. 6B and 6C, cell 202 represents the basic functional unit for fuel cell 200. Anode structure 206 includes a porous construction similar to that described above with respect to cell 104, with a hydrogen catalyst disposed on external and internal surfaces of the porous structure 206. Similarly, cathode structure 208 includes a porous construction with an oxygen catalyst disposed on surfaces of the porous structure 208. Electrolyte 218 is deposited around each cell 202, and thus forms an electrolyte layer about each anode structure 206 and cathode structure 208.

Anode structures 206 and cathode structures 208 in this case each include a cross sectional platelet shape. The platelet shape extends up from chassis 214 vertically as shown to a height, h, which is determined by design. This platelet shape maintains high surface area interaction with reactants. Other shapes may be used. Similar to the tubular structures above, cell provides 3-D control of dimensions for each cell. More specifically, a designer may alter the cross-sectional platelet (or elliptical) shape in the plane as well as the height. Packing and arrangement of cells 204 also provides power density control at levels far greater than available with conventional stacked plate designs. In one embodiment, anode structure 206 and cathode structure 208 each have a height from about 10 micrometers to about 400 micrometers and a cell width, w, of from about 10 micrometers to about 100 micrometers. In a specific embodiment, anode structure 206 and cathode structure 208 each have a height of about 100 micrometers and a cell width of about 34 micrometers. Other dimensions may be used.

The platelet shape of anode structures 206 and cathode structures 208 also affects functional distance between neighboring anode structures 206 and cathode structures 208. This may affect electrical performance of fuel cell 200. One embodiment of the invention avoids crosstalk between adjacent cathode structures and adjacent anode structures. Crosstalk will depend on the distance between adjacent cathode structures and between anode structures and cathode structures, and depend on the electrolyte material. As shown in FIG. 6D, a distance, d₁, characterizes the distance between an anode structure 206 and cathode structure 208 in a cell 202. Distance, d₂, characterizes the distance between adjacent anode structures 206 in a row 204 (or adjacent cathode structures 208). Preferably, d₁ and d₂ are dimensioned to reduce crosstalk.

Interconnects 216 provide anode and cathode electrical connectivity and pass through the bottom chassis 214. More specifically, a conductive material electrically contacts each anode structure 206, traverses through the insulating chassis 214, and electrically contacts a bus layer 220 that electrically couples each interconnect 216 and provides gross electrical communication for fuel cell 200.

Cells 202 and a bus layer 220 may be electrically linked according to design. For example, fuel cell 200 permits redundant electrical provision if desired. Bus layer 220 also permits flexible electrical connectivity between anode structures 206 and cathode structures 208. For example, fuel cell 200 may offer a high voltage range of electrical output by connecting numerous cells 202 in series. FIG. 6E illustrates electrical conduction between two cells 202 as driven by connectivity in the bus layer. In this case, cells 202 are connected in series to add the potential generated in each cell. A path 260 shows the electrical circuit enabled by electrical connectivity in the bus layer. The cumulative anode for fuel cell 200 then includes each cell 202 connected in series and conducts electrons to an external electrical load (electricity is used) or battery (energy is stored). In some cases, each cell 202 may be switched in and out of electrical supply for fuel cell 200 using a controller that addresses each cell 202 and operates a switch that allows each cell to be cut off from external electrical communication.

This arrangement provides a fuel cell 200 with lateral current conduction and switching capability for individual cells. Since the main building unit is micron scale thick, hundreds of cells 202 can be located on a single chip with small dimensions. For example, a chip about 1 cm×1 cm×0.1 cm may produce power densities from about 20 watts/cm³ to about 250 watts/cm³. The platelet cells 202 also offer high functional surface area for chemical reactivity and electrical generation. This offers a dramatic improvement in power density when compared to the standard bi-polar plate, strip cell or macro-tubular fuel cells. At best, current micro-fuel cell technology can achieve a power density about 2.5 kW/L, or about 2.5 W watts/cm³. Depending on the thickness of the platelet cell, the 3-D fuel cell 200 offers 20-50 times the functional surface area available in planar fuel cells, and 50-100 times the functional surface area of macro-tubular fuel cells. Hence, the power density of the 3-D fuel cells described herein can approach 1.00-250 watts/cm³.

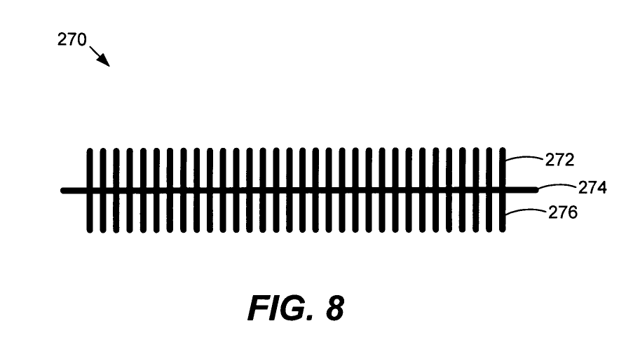

Other 3-D designs and architectures are permissible other than the exemplary designs described. FIG. 8 shows a dual sided layer 270 in which anode structures 272 are disposed on one face of a single chassis 274 and cathode structures 276 are disposed on the opposite face of single chassis 274 in accordance with a specific embodiment of the present invention. Multiple layers 270 may be vertically stacked so anode structures 272 on one layer 270 face anode structures 272 on an adjacent layer 270 and share a common hydrogen supply. Similarly, cathode structures 276 an adjacent layers 270 may share a common oxygen supply and product removal channel.

While the present invention has mainly been discussed so far with respect to a direct hydrogen fuel cell or reformed methanol fuel cell (RMFC), 3-D architectures described herein may also apply to other types of fuel cells, such as a solid oxide fuel cell (SOFC), a phosphoric acid fuel cell (PAFC), a direct methanol fuel cell (DMFC), or a direct ethanol fuel cell (DEFC). In this case, the fuel cell includes components specific to these architectures, as one of skill in the art will appreciate. A DMFC or DEFC receives and processes a fuel. More specifically, a DMFC or DEFC receives liquid methanol or ethanol, respectively, channels the fuel to the individual cells and processes the liquid fuel to separate hydrogen for electrical energy generation. Distribution manifolds may then deliver liquid methanol instead of hydrogen. The hydrogen catalyst would include a suitable anode catalyst for separating hydrogen from methanol. The oxygen catalyst would include a suitable cathode catalyst for processing oxygen or another suitable oxidant used in the DMFC, such as peroxide. In general, hydrogen catalyst is also commonly referred to as an anode catalyst in other fuel cell architectures and may comprise any suitable catalyst that removes hydrogen for electrical energy generation in a fuel cell, such as directly from the fuel as in a DMFC. In general, an oxygen catalyst (or cathode catalyst) employed in a 3-D fuel cell may include any catalyst that processes an oxidant in used in the fuel cell. The oxidant may include any liquid or gas that oxidizes the fuel and is not limited to oxygen gas as described above. An SOFC, PAFC or MCFC may also benefit from inventions described herein, for example. In this case, the fuel cell comprises an anode catalyst, cathode catalyst, anode fuel and oxidant according to a specific SOFC, PAFC or MCFC design.

### Fabrication

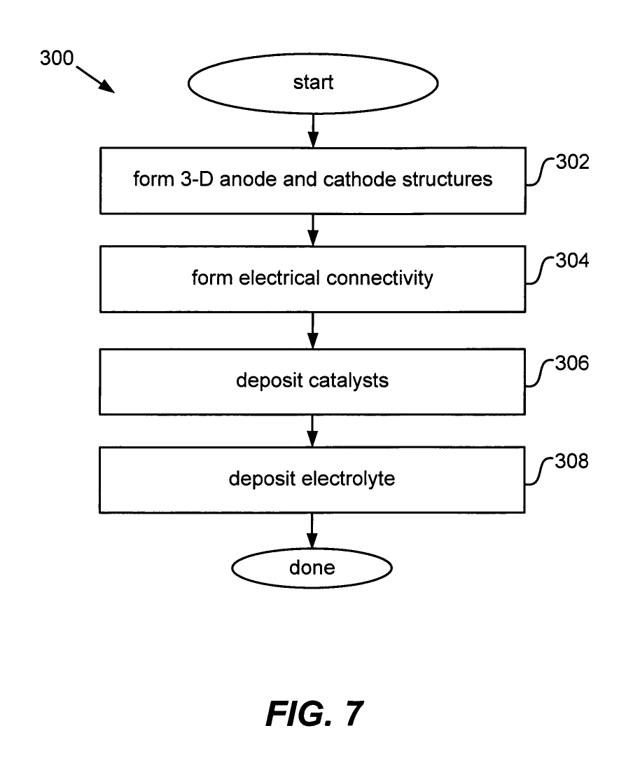

Having described several exemplary fuel cells and cell configurations, fabrication of fuel cells will now be expanded upon. The 3-D architectures described herein may be fabricated using wafer-processing technologies that permit control of dimensions in the micron range and allow for deposition of materials onto and into etched structures. FIG. 7 illustrates a manufacturing process 300 for fabricating a fuel cell in accordance with one embodiment of the present invention.

Manufacturing process 300 begins by forming the anode and cathode structures (302) and forming the electrical connectivity (304). The anode and cathode structures, interconnects and insulator layers may be manufactured using conventional MEMS manufacturing methods, DRIE etching, metal deposition, and other wafer-scale manufacturing techniques. In one embodiment, the insulating chassis begins as a wafer and the anode and cathode structures are formed by depositing and etching doped silicon. A reactive ion etch is suitable for use in many cases. These techniques may fabricate up to 1000 cells within a square centimeter.

In one embodiment, etching out vias in a wafer substrate and depositing metal interconnects into the vias forms the electrical connections (304). The cells may then be electrically connected in a series/parallel arrangement, on the wafer conductor layer to produce a desired fuel cell voltage. A switching chipset may also be connected to the electrical interconnects. This controller provides voltage regulation of the fuel cell output, and can also be used to produce specific voltage waveforms as required for mobile applications such as GSM wireless communications.

Steps 302 and 304 need not occur in the order shown. For example, the electrical connections may first be formed by etching out vias in a wafer, depositing metal interconnects, and then adding and etching material used to form the anode and cathode structures on top of the already established metal interconnects.

Catalysts are then deposited onto the anode and cathode structures (306). One method to deposit catalysts on porous or non-porous structures includes pumping a catalyst suspension into the anode and cathode cavities. One suitable catalyst suspension contains 5-40% by weight catalytically active particles and 50-95% by weight 1-methoxy, 2-propanol (“MOP”). Other catalyst suspensions are suitable for use. The catalytically active particles may include platinum black, which is commercially available from a wide array of vendors such as ETEK Inc. of Somerset, N.J. or platinum on Vulcan XC-72 carbon, for example. The assembly may then be heated to remove excess solvent and alter the catalyst, if needed. For example, one assembly may be heated to about 100-300° C. under a reducing environment (such as hydrogen gas) in order to evaporate excess solvent and reduce the platinum chloride to Pt. The deposition and heating may be repeated to deposit additional catalyst. For example, the above two steps can be repeated until a desired catalyst loading is achieved on active areas of the anode and cathode structures. One suitable catalyst loading ranges anywhere from about 0.2 mg/cm² to about 5 mg/cm².

A catalyst coating may also be applied using vapor deposition or salt evaporated platinum black, for example. Other methods may be used to deposit a catalyst on the anode and cathode structures. Some methods include sputtering, electroplating or metal salt deposition of aqueous chloroplatinic acid, for example.

Process flow 300 proceeds by depositing electrolyte (308). Where the electrolyte rests in the fuel cell is a matter of design and may affect electrolyte deposition and the method used, as one of skill in the art will appreciate. A liquid electrolyte may be poured or sprayed into a sealed cavity, once sealed. One robust method to deposit electrolyte into space between the anode and cathode structures despite complex geometries and arrangements includes a) blocking the cathode and anode inlet and outlet ports on the bonded wafer set or fuel cell assembly and b) pumping the electrolyte into the closed volume. In a specific embodiment, the electrolyte is pumped into the anode inlet using an elevated pressure until some stop criteria is reached. For example, a roughly fixed pressure of about 5-20 psig will force electrolyte into the closed volume, and this may continue until the flow rate slows to less than 1 ml/hour. One electrolyte suitable includes 85% phosphoric acid or Nafion 550 solution. Once the stop criterion has been reached, the inlet ports are opened to purge the anode and cathode cavities with air. In the case of Nafion 550, the fuel cell is also heated to remove any solvents and also the invert the mi-cellular structure of the Nafion. The pumping and purging steps may be repeated to provide a more thorough electrolyte deposition. In a specific embodiment, the pumping and purging steps repeat until an air leak rate threshold has been reached between the anode and cathode. For example, an air leak rate less than about 1 cc/min/cm² of active area may be suitable at 2 psi delta P. Capillary forces may then hold the electrolyte in the matrix structure.

Wicking may also be used to deposit an electrolyte into the fuel cell. A molten salt, such as one including a phosphate salt, may also be heated to its melting point, wicked into a structure with complex surfaces, and then cooled to solidify in place. Solid electrolytes may also be applied using chemical vapor deposition (CVD) and physical vapor deposition (PVD) techniques.

While this invention has been described in terms of several preferred embodiments, there are alterations, permutations, and equivalents that fall within the scope of this invention, which have been omitted for brevity's sake. It is therefore intended that the scope of the invention should be determined with reference to the appended claims.

1. A fuel cell for generating electrical energy, the fuel cell comprising:
a set of cells arranged on at least one chassis, each cell including
an anode structure that extends from the at least one chassis and supports a hydrogen catalyst,
a cathode structure that extends from the at least one chassis and supports a cathode catalyst, and
an electrolyte disposed to electrically isolate the anode structure from the cathode structure and permit passage of ions between the anode structure and the cathode structure;
a hydrogen distribution channel configured to deliver hydrogen to the anode structures in the set of cells; and
an oxygen distribution channel configured to deliver oxygen to the cathode structures in the set of cells.

2. The fuel cell of claim 1 wherein the at least one chassis is substantially planar and the anode structure and the cathode structure extend about normal to the substantially planar chassis.

3. The fuel cell of claim 2 wherein the oxygen distribution channel is about parallel to the planar chassis and the hydrogen distribution channel for each anode structure is about normal to the planar chassis.

4. The fuel cell of claim 2 wherein the anode structure and the cathode structure include substantially tubular dimensions and include a central axis that is about normal to the planar chassis.

5. The fuel cell of claim 2 wherein the anode structure includes a dimension normal to the planar chassis that is greater than a dimension for the anode structure that it parallel to the planar chassis.

6. The fuel cell of claim 1 wherein the anode structure for the set of cells extends from a first chassis and the cathode structure for the set of cells extends from a second chassis.

7. The fuel cell of claim 1 wherein at least one chassis includes a wafer substrate and the anode structure for each cell is etched from a material deposited onto the wafer substrate.

8. The fuel cell of claim 1 further comprising electrical connectivity to the anode structure and the cathode structure.

9. The fuel cell of claim 8 wherein electrical connectivity to the anode structure is separate from electrical connectivity to the cathode structure.

10. The fuel cell of claim 8 further comprising independent electrical connectivity each anode structure and each cathode structure in the fuel cell.

11. The fuel cell of claim 1 wherein the anode structure includes a porous structure and the hydrogen catalyst is coated onto surfaces of the porous structure.

12. The fuel cell of claim 1 wherein the cathode structure includes a porous structure and the cathode catalyst is coated onto surfaces of the porous structure.

13. The fuel cell of claim 1 further comprising multiple electrical outputs.

14. The fuel cell of claim 1 wherein the fuel cell is configured to provide a voltage range for electrical energy output by the fuel cell.

15. The fuel cell of claim 1 wherein the fuel cell does not include a dc/dc converter.

16. The fuel cell of claim 1 wherein the fuel cell includes a redundant number of cells relative to electrical energy output for the fuel cell.

17. The fuel cell of claim 16 wherein less than 80 percent of the cells in the fuel cell are used to generate electrical energy for the fuel cell.

18. The fuel cell of claim 17 further comprising a controller that determines which cells in the fuel cell are used to generate electrical energy.

19. The fuel cell of claim 1 wherein the fuel cell is included in a portable electronics device.

20. The fuel cell of claim 19 wherein the fuel cell includes a first voltage supply to a first component in the electronics device and a second voltage supply to a second component, where the first voltage supply is less than the second voltage supply.

21. The fuel cell of claim 20 wherein the electronics device is a cell phone and the first component is one of a screen for the cell phone, a transmitter for the cell phone, or a CPU for the cell phone.

22. The fuel cell of claim 1 wherein the fuel cell occupies less than about 5 cubic centimeters.

23. The fuel cell of claim 22 wherein the fuel cell occupies less than about 1 cubic centimeter.

24. The fuel cell of claim 1 wherein the fuel cell provides a power density greater than about 20 watts per cubic centimeter.

25. The fuel cell of claim 24 wherein the fuel cell provides a power density greater than about 100 watts per cubic centimeter.

26. A fuel cell for generating electrical energy, the fuel cell comprising:
a set of cells arranged on at least one chassis, each cell including
an anode structure that extends from the at least one chassis and supports a hydrogen catalyst,
a cathode structure that extends from the at least one chassis and supports a cathode catalyst, and
an electrolyte disposed to electrically isolate the anode structure from the cathode structure and permit passage of ions between the anode structure and the cathode structure;
a hydrogen distribution channel configured to deliver hydrogen to the anode structures in the set of cells; and
an oxygen distribution channel configured to deliver oxygen to the cathode structures in the set of cells,
wherein the fuel cell provides a power density of greater than about 20 Watts/cubic centimeter according to a volume of the fuel cell.

27. The fuel cell of claim 26 wherein the fuel cell provides a power density greater than about 100 watts per cubic centimeter.

28. The fuel cell of claim 26 further comprising independent electrical connectivity each anode structure and each cathode structure in the fuel cell.

29. The fuel cell of claim 26 wherein the anode structure includes a porous structure and the hydrogen catalyst is coated onto surfaces of the porous structure.

30. The fuel cell of claim 26 wherein the fuel cell is configured to provide a voltage range for electrical energy output by the fuel cell.

31. The fuel cell of claim 26 wherein the fuel cell includes a redundant number of cells relative to electrical energy output for the fuel cell.

32. The fuel cell of claim 26 wherein the fuel cell occupies less than about 1 cubic centimeter.

33. A fuel cell for generating electrical energy, the fuel cell comprising:
a set of cells arranged on at least one chassis, each cell including
an anode structure that extends from the at least one chassis and supports a hydrogen catalyst,
a cathode structure that extends from the at least one chassis and supports a cathode catalyst, and
an electrolyte disposed to electrically isolate the anode structure from the cathode structure and permit passage of ions between the anode structure and the cathode structure;
a hydrogen distribution channel configured to deliver hydrogen to the anode structures in the set of cells;
an oxygen distribution channel configured to deliver oxygen to the cathode structures in the set of cells; and
independent electrical connectivity to the anode structure and the cathode structure in each cell.

34. The fuel cell of claim 33 wherein electrical connectivity to the anode structure is separate from electrical connectivity to the cathode structure.

35. The fuel cell of claim 33 further comprising independent electrical connectivity each anode structure and each cathode structure in the fuel cell.

36. The fuel cell of claim 33 further comprising multiple electrical outputs.

37. The fuel cell of claim 33 wherein the fuel cell is configured to provide a voltage range for electrical energy output by the fuel cell.

38. The fuel cell of claim 33 wherein the fuel cell does not include a dc/dc converter.

39. The fuel cell of claim 33 wherein the fuel cell includes a redundant number of cells relative to electrical energy output for the fuel cell.

40. The fuel cell of claim 39 wherein less than 80 percent of the cells in the fuel cell are used to generate electrical energy for the fuel cell.

41. The fuel cell of claim 40 further comprising a controller that determines which cells in the fuel cell are used to generate electrical energy.

42. The fuel cell of claim 41 wherein the fuel cell occupies less than about 1 cubic centimeter.

43. The fuel cell of claim 42 wherein the fuel cell provides a power density greater than about 100 watts per cubic centimeter.

44. A method of fabricating a fuel cell, the method comprising:
forming a set of set of anode structures that each extend from at least one planar chassis and a set of set of cathode structures that each extend from the at least one planar chassis;
forming electrical connectivity with the set of anode structures and the set of cathode structures;
depositing an anode catalyst onto surfaces of the set of anode structures;
depositing a cathode catalyst onto surfaces of the set of cathode structures; and
depositing an electrolyte at least partially between the set of anode structures and the set of cathode structures.

45. The method of claim 44 wherein forming a set of set of anode structures includes etching the set of anode structures from a material deposited onto a wafer substrate.

46. The method of claim 45 wherein the substrate is included in the at least one support chassis.

47. The method of claim 45 wherein forming the electrical connectivity for the set of anode structures includes:
etching a set of vias in the substrate; and
depositing a conductive material in the set of vias.

48. The method of claim 44 wherein depositing the cathode catalyst includes pumping a catalyst suspension including the cathode catalyst into a cavity including the set of cathode structures.

49. The method of claim 48 further comprising applying heat to the cavity to evaporate solvent used in the catalyst suspension.

50. The method of claim 44 further comprising:
blocking inlet and outlet ports to the fuel cell; and
pumping the electrolyte into the closed volume.
